(19) United States
(12) Patent Application Publication
(10) Pub. No.: US 2023/0165315 A1
(43) Pub. Date: Jun. 1, 2023

(54) DEVICE FOR AIR CONDUCTION HEATING

(71) Applicant: Smiss Technology Co., Ltd., Shenzhen (CN)

(72) Inventors: Jiatai CHEN, Shenzhen (CN); Shikai CHEN, Shenzhen (CN); Caihui DONG, Shenzhen (CN); Xiaotong XIE, Shenzhen (CN)

(73) Assignee: Smiss Technology Co., Ltd., Shenzhen (CN)

(21) Appl. No.: 17/578,180

(22) Filed: Jan. 18, 2022

(30) Foreign Application Priority Data
Dec. 1, 2021 (CN) 202122995495.4

(51) Int. Cl. A24F 40/57; G05D 23/19; G05D 23/22; F24H 15/37; H05B 3/46; G01K 7/02; G01K 7/22; A24F 40/46; A24F 40/51; A24F 40/48

(52) U.S. Cl. CPC A24F 40/57; A24F 40/46; A24F 40/48; A24F 40/51; F24H 15/37; G01K 7/02; G01K 7/22; G05D 23/22; G05D 23/1931; H05B 3/46; A24F 40/20

(57) ABSTRACT

A device for air conduction heating, which includes: a heating conduit, a temperature detection module and a main control module. An inner cavity of the heating conduit is provided with a separation screen, the separation screen is configured to divide the inner cavity into a smoke chamber and a heating chamber in which a heating device is provided. The temperature detection module includes a first temperature sensor arranged on the smoke chamber and a second temperature sensor arranged on the separation screen. The main control module is electrically connected to the heating device and the temperature detection module respectively, and is configured to adjust a working power of the heating device according to a relationship between a preset temperature threshold temperature and a detection temperature collected by the temperature detection module. The detection temperature includes a temperature of the smoke chamber and a heating temperature.

### CROSS-REFERENCE TO RELATED APPLICATION

Pursuant to 35 U.S.C. § 119 and the Paris Convention, this application claims the benefit of Chinese Patent Application No. 202122995495.4 filed Dec. 1, 2021, the content of which is incorporated herein by reference.

### TECHNICAL FIELD

The present application relates to the field of heating devices, and particularly to a device for air conduction heating.

### BACKGROUND

As people pay more and more attention to health, the number of smokers has gradually decreased, and as a substitute for cigarettes, smoking sets have been rapidly popularized in the market.

At present, traditional smoking sets includes products that heat tobacco contained in the smoking set by means of heat conduction mechanism. By inhaling gases generated by heating the tobacco, not only the demand for smoking can be met, but also harmful substances produced by a burning of the tobacco is reduced. However, the traditional smoking sets usually do not perform a fully detection of temperature, which leads to problems that the heating temperature is too high, which causes the tobacco to be over-heated, and even the tobacco is directly burned.

### SUMMARY

An object of the present application is to provide a device for air conduction heating, which aims to solve the problem that the temperature detection in the traditional smoking sets is not comprehensive.

In accordance with a first aspect of embodiments of the present application, it is provided a device for air conduction heating, which includes a heating conduit, a temperature detection module and a main control module. An inner cavity of the heating conduit is provided with a separation screen, and the separation screen is configured to separate the inner cavity into a smoke chamber and a heating chamber in which a heating device is provided. The temperature detection module includes a first temperature sensor arranged on the smoke chamber and a second temperature sensor arranged on the separation screen. The first temperature sensor is configured to collect a smoke-chamber temperature of the smoke chamber, and the second temperature sensor is configured to collect a heating temperature of the separation screen. The main control module is electrically connected to the heating device and the temperature detection module. The main control module is configured to adjust a working power of the heating device according to a relationship between a preset temperature threshold and a detection temperature collected by the temperature detection module, and the detection temperature includes the smoke-chamber temperature and the heating temperature.

In one embodiment, one end of the heating chamber is also provided with an air inlet, and one end of the smoke chamber is provided with an air outlet, so that an air-heating diversion channel from the air inlet to the air outlet is formed in the heating conduit.

In one embodiment, the heating device includes a heat-conducting rod and a heating wire. The heat-conducting rod is fixed in the heating chamber, and the heating wire is wound on a surface of the heat-conducting rod.

In one embodiment, the heat-conducting rod is provided with a through hole along an axial direction of the heat-conducting rod. The surface of the heat-conducting rod is provided with a spiral groove, and a heating airway is formed between the spiral groove and an inner wall of the heating chamber. One end of the heating airway is in communication with the air inlet, the other end of the heating airway is in communication with the separation screen. The heating wire passes through the through hole and is spirally wound on the surface of the thermally conductive rod along the spiral groove.

In one embodiment, the first temperature sensor includes a plurality of thermistors connected to the main control module, and the plurality of thermistors are dispersed and fixed on an outer wall of the smoke chamber, and the main control module obtains the temperature of the smoke chamber through the plurality of thermistors.

In one embodiment, the second temperature sensor includes a thermocouple, and a hot end of the thermocouple is arranged on the separation screen.

In one embodiment, the second temperature sensor further includes a first voltage divider resistor, a second voltage divider resistor, a third voltage divider resistor, a fourth voltage divider resistor, a fifth voltage divider resistor, an operational amplifier, and a compensation thermistor. The hot end of the thermocouple is connected to a non-inverting input end of the operational amplifier through the first voltage divider resistor. A cold end of the thermocouple is connected to an inverting input end of the operational amplifier through the second voltage divider resistor. An output end of the operational amplifier is connected to the inverting input end of the operational amplifier through the third voltage divider resistor. The non-inverting input end of the operational amplifier is also grounded through the fourth voltage divider resistor. The cold end of the thermocouple is also connected to a working voltage end through the fifth voltage divider resistor. The cold end of the thermocouple is also grounded through the compensation thermistor. The output end of the operational amplifier is connected to the main control module.

In one embodiment, the temperature detection module further includes a resistance detection module. The resistance detection module includes a detection resistor. The detection resistor is connected in series with the heating wire and is grounded. The resistance detection module is configured to collect a voltage at two ends of the detection resistor. The main control module is also configured to obtain a temperature of the heating wire according to the voltage at the two ends.

In one embodiment, the preset temperature threshold includes a first heating temperature threshold and a second heating temperature threshold. The first heating temperature threshold is less than the second heating temperature threshold. The main control module is also configured to control the heating device to perform heating at a rated power when the heating temperature is smaller than the first heating temperature threshold; to control the heating device to perform heating at a power lower than the rated power after the heating temperature reaches the first heating temperature threshold, and to control the heating device to stop heating for a preset time when the heating temperature reaches the second heating temperature threshold.

In accordance with a second aspect of the embodiments of the present application, it is provided a smoking set, which includes the above-mentioned device for air conduction heating.

Compared with the existing technologies, the embodiments of the present application have the following beneficial effects: the heating device in the heating chamber perform heating on air in the heating chamber, and gases generated after the tobacco in the smoke chamber is heated through high-temperature air can satisfy a user’s demand for smoking. Structures are in direct contact with the tobacco, so that the temperature of the smoke chamber is a temperature that the user is actually exposed to when smoking, and the heating temperature is the highest temperature to which the tobacco can be exposed during the heating process. By controlling the temperature of the smoke chamber, the user experience can be guaranteed, and a temperature of the inhaled gases can be prevented from being too high or too low. By controlling the heating temperature, it can be ensured that when the tobacco is heated, the temperature of the tobacco can be prevented from being too high, which causes the tobacco to be over-heated or even burned.

### BRIEF DESCRIPTION OF THE DRAWINGS

FIG. 1 is a schematic longitudinal cross-sectional view of a device for air conduction heating in accordance with an embodiment of the present application;

FIG. 2 is an example circuit diagram of a second temperature sensor in accordance with an embodiment of the present application; and

FIG. 3 is an example circuit diagram of a resistance detection module in accordance with an embodiment of the present application.

Reference symbols in the drawings: 100 heating conduit; 110 separation screen; 120 smoke chamber; 121 air outlet; 130 heating chamber; 131 heating device; 132 air inlet; 133 heat-conducting rod; 134 heating wire 135 through hole; 136 spiral groove; 137 resistance detection module; 200 temperature detection module; 210 first temperature sensor; 220 second temperature sensor; 300 main control module; 400 power supply; 500 heat-insulating conduit; 600 base.

### DETAILED DESCRIPTION OF THE EMBODIMENTS

In order to make the technical problems to be solved, technical solutions, and beneficial effects of the present application more comprehensible, the present application will be further described in detail below with reference to the drawings and embodiments. It should be understood that the embodiments specifically described here are merely used to illustrate the present application, and are not intended to limit the present application.

It should be noted that when an element is referred to as being “fixed to” or “disposed/provided on” another element, it can be directly or indirectly on the other element. When an element is referred to as being “connected to” another element, it can be directly or indirectly connected to the other element.

It should be understood that direction or position relationship indicated by terms of “length,” “width,” “upper,” “lower,” “front,” “back,” “left,” “right,” “vertical,” “horizontal,” “top,” “bottom,” “inner,” “outer” and the like, are based on the orientation or position relationship shown in the drawings, which are merely used for the convenience of describing the present application and simplifying the description, rather than indicating or implying that the device or element referred to must have a specific orientation, be constructed and operated in a specific orientation, it thus cannot be understood as a limitation to the present application.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present application, the phrases “a/the plurality of” means two or more, unless otherwise specifically defined.

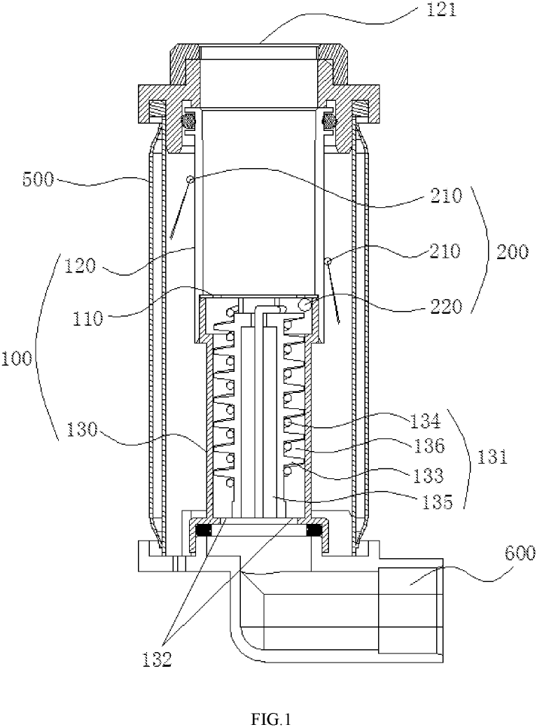

FIG. 1 shows a schematic longitudinal cross-sectional view of the device for air conduction heating provided by a first embodiment of the present application. For ease of description, only parts related to this embodiment are shown, and the details are as follows:

A device for air conduction heating, which includes: a heating conduit 100, a temperature detection module 200, and a main control module 300. An inner cavity of the heating conduit 100 is provided with a separation screen 110. The separation screen 110 is configured to separate the inner cavity of the heating conduit 100 into a smoke chamber 120 and a heating chamber 130. A heating device 131 for heating air in the heating chamber 130 is disposed inside the heating chamber 130. The temperature detection module 200 includes a first temperature sensor 210 arranged at an outside of a side wall of the smoke chamber 120, and a second temperature sensor 220 arranged on the separation screen 110. The first temperature sensor 210 is configured to collect a temperature (smoke-chamber temperature) of the smoke chamber 120. The second temperature sensor 220 is configured to collect a temperature (heating temperature) of the separation screen 110. The main control module 300 is electrically connected to the heating device 131 and the temperature detection module 200 respectively. The main control module 300 is configured to adjust a working power of the heating device 131 or turn off the heating device 131 according to the relationship between a preset temperature threshold and the detected temperature collected by the temperature detection module 200.

The detected temperature includes the smoke-chamber temperature detected by the first temperature sensor 210 and the heating temperature detected by the second temperature sensor 220. The preset temperature thresholds include a smoke chamber temperature threshold, a first heating temperature threshold, and a second heating temperature threshold. The heating temperature threshold is smaller than the second heating temperature threshold.

The main control module 300 is configured to always control the heating device 131 to perform heating at a rated power when the smoke-chamber temperature is less than the smoke-chamber temperature threshold and the heating temperature is less than the second heating temperature threshold. The main control module 300 is configured to control the heating device 131 according to the heating temperature when the smoke-chamber temperature reaches the smoke-chamber temperature threshold. In an exemplary embodiment, when the heating temperature is smaller than the first heating temperature threshold, the main control module 300 is configured to control the heating device 131 to perform heating at the rated power. After the heating temperature reaches the first heating temperature threshold, the main control module 300 is configured to control the heating device 131 to perform heating at a power lower than the rated power. When the heating temperature reaches the second heating temperature threshold, the main control module 300 is configured to control the heating device 131 to stop heating for a preset time, which may be three seconds, to adjust the heating temperature and prevent the heating temperature from being too high.

The heating device 131 in the heating chamber 130 is configured to heat the air in the heating chamber 130. After the heated air having high temperature enters into the smoke chamber 120, the tobacco in the smoke chamber 120 will be heated, so that the smoke that can satisfy the user is generated without burning the tobacco.

The smoke chamber 120 and the separation screen 110 are physical structures that directly contact the tobacco, the temperature of the smoke chamber 120 can reflect the temperature to which the user may be directly exposed, and the temperature of the separation screen 110 is the highest temperature that the tobacco can be exposed to during a heating process. By controlling the temperature of the smoke chamber 120, the user experience can be ensured, and the temperature of the air flowing out of an air outlet 121 can be prevented from being too high or too low. By controlling the temperature of the separation screen 110, it can be ensured that when heating tobacco, heat accumulation on the separation screen 110 will not cause the temperature of the separation screen 110 to be too high, which causes the tobacco to be over-heated or even burned, affecting the user experience.

In this embodiment, an end of the heating chamber 130 away from the separation screen 110 is provided with an air inlet 132, and an end of the smoke chamber 120 away from the separation screen 110 is provided with an air outlet 121, so that an air-heating diversion channel from the air inlet 132 to the air outlet 121 is formed in the heating conduit 100. The air enters from the air inlet 132, is fully heated in the heating chamber 130, passes through the separation screen 110 and enters into the smoke chamber 120, and then heats the tobacco in the smoke chamber 120 and finally inhalable smoke is generated. In this process, the temperature of the separation screen 110 will also continue to rise.

In this embodiment, the heating device 131 includes a heat-conducting rod 133 and a heating wire 134. The heat-conducting rod 133 is fixed in the heating chamber 130; the heating wire 134 is wound on a surface of the heat-conducting rod 133. The heating wire 134 is configured to heat the air in the heating chamber 130, and the heat-conducting rod 133 can assist the heating wire 134 to heat the air in the heating chamber 130, thereby improving heating efficiency.

In this embodiment, the heat-conducting rod 133 is provided with a through hole 135 along an axial direction of the heat-conducting rod 133. The surface of the heat-conducting rod 133 is provided with a spiral groove 136. One end of the heating wire 134 passes through the through hole 135 and is spirally wound on the surface of the heat-conducting rod 133 along the spiral groove 136. A heating airway is formed between the spiral groove 136 and the inner wall of the heating chamber 130, one end of the heating airway is in connection with the air inlet 132, and the other end of the heating airway is in connection with the separation screen 110.

The heat-conducting rod 133 can conduct the heat from the heating wire 134, meanwhile the heating airway formed by the spiral groove 136 can extend the time that the air stays in the heating chamber 130, and can make full use of the heating wire 134 in the spiral groove 136 to heat the air to improve a heating effect of the air.

Among them, the heat-conducting rod 133 may be made of an insulation material having high-temperature resistance, such as ceramics, which can prevent the heat-conducting rod 133 from being greatly deformed under the heating of the heating wire 134 and prevent the heat-conducting rod 133 from conducting electricity.

In this embodiment, the first temperature sensor 210 includes one or more thermistors connected to the main control module 300. When a plurality of thermistors are provided, each thermistor is scattered and fixed on the outside of the side wall of the smoke chamber 120, so that the smoke chamber 120 is detected comprehensively. The number of thermistors can be adjusted according to actual needs, and the main control module 300 may obtain a specific actual temperature of the smoke chamber 120 by detecting the resistance of each thermistor. In this embodiment, two thermistors are provided in total.

Among them, the thermistors may all be NTC (Negative Temperature Coefficient) resistors. In this embodiment the resistance of the thermistor decreases when the temperature of the smoke chamber 120 increases. By detecting the resistance of the thermistor, the actual temperature of the smoke chamber 120 can be obtained.

In this embodiment, the second temperature sensor 220 includes a thermocouple, and a hot end T+ of the thermocouple is fixed on the separation screen 110 for detecting the temperature of the separation screen 110.

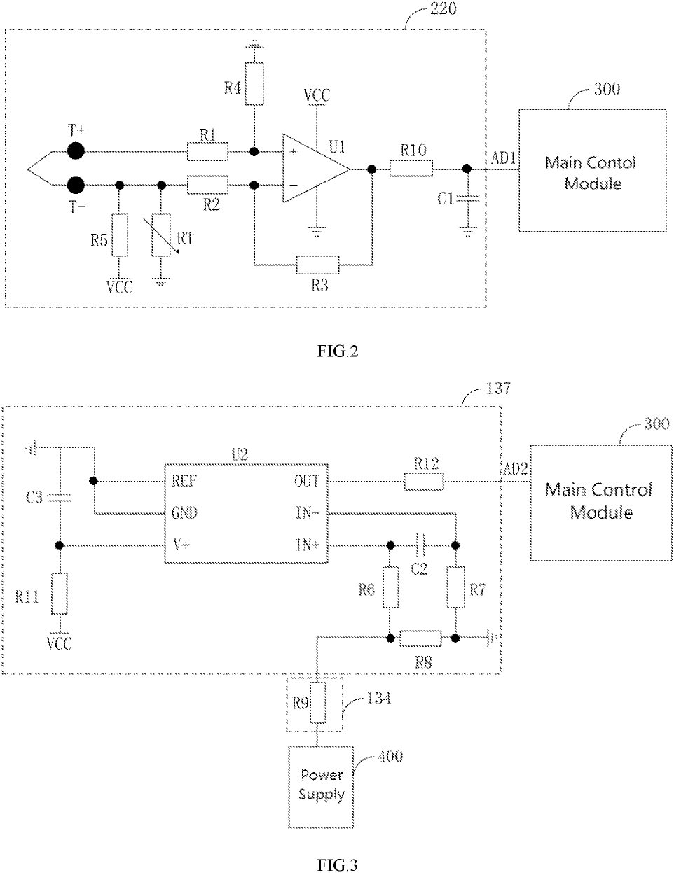

As shown in FIG. 2, in this embodiment, the second temperature sensor 220 also includes a first voltage divider resistor R1, a second voltage divider resistor R2, a third voltage divider resistor R3, a fourth voltage divider resistor R4, a fifth voltage divider resistor R5, an operational amplifier U1 and a compensation thermistor RT.

The hot end T+ of the thermocouple is electrically connected to a non-inverting input end of the operational amplifier U1 through the first voltage divider resistor R1, and a cold end T- of the thermocouple is electrically connected to an inverting input end of the operational amplifier U1 through the second voltage divider resistor R2. An output end of the operational amplifier U1 is connected to the inverting input end of the operational amplifier U1 through the third voltage divider resistor R3.

The non-inverting input end of the operational amplifier U1 is also grounded through the fourth voltage divider resistor R4, and the cold end T- of the thermocouple is also connected to a working voltage end VCC through the fifth voltage divider resistor R5. The cold end T- of the thermocouple is also grounded through the compensation thermistor RT.

The compensation thermistor RT is configured to detect an ambient temperature and compensate the voltage of the cold end T- of the thermocouple according to the ambient temperature, so that the voltage at the inverting input end of the operational amplifier U1 remains the same under different ambient temperatures, thereby improving the detection accuracy of the second temperature sensor 220.

As shown in FIG. 2, in this embodiment, the output end of the operational amplifier U1 is also provided with a filter circuit for filtering the detection voltage output by the operational amplifier U1. The output end of the operational amplifier U1 is connected to the first input end AD1 of the main control module 300 through the filter circuit for transmitting the detection voltage obtained by the operational amplifier U1 to the main control module 300. The main control module 300 obtains a heating temperature detected by the temperature sensor 220 according to the detection voltage.

Among them, the filter circuit includes a filter resistor R10 and a filter capacitor C1. The filter resistor R10 is connected in series between the output end of the operational amplifier U1 and the main control module 300. One end of the filter capacitor C1 is connected to one end of the filter resistor R10, and the other end of the filter capacitor C1 is grounded.

When the heating device 131 starts to heat, the heating wire 134 continuously heats the air entering the heating chamber 130, and the heated air finally enters into the smoke chamber 120 through the separation screen 110. During this process, the temperature of the separation screen 110 will continue to rise. When a temperature difference between a hot end T+ of the second temperature sensor 220 and a cold end T- of the second temperature sensor 220 is occurred, an electromotive force is generated between the hot end T+ of the second temperature sensor 220 and the cold end T-of the second temperature sensor 220, and the operational amplifier U1 generates a corresponding detection voltage according to the voltage levels of the non-inverting input end and the inverting input end of the operational amplifier U1, that is, the temperature of the hot end T+ of the second temperature sensor 220 can be obtained according to the detection voltage.

It should be noted that the cold end T- of the second temperature sensor 220 should theoretically be set in an environment with a constant temperature. In this embodiment, the influence of the ambient temperature on the cold end T- of the second temperature sensor 220 can be offset by compensating the thermistor RT, so that the voltage transmitted from the cold end T- of the second temperature sensor 220 to the inverting input end of the operational amplifier U1 remains relatively constant, achieving the purpose of detecting the temperature of the hot end T+ of the second temperature sensor 220, thereby achieving a temperature detection of the separation screen 110.

The high temperature of the separation screen 110 can increase the temperature of the tobacco. The first temperature sensor 210 provided in the smoke chamber 120 cannot detect the temperature of the separation screen 110 at the first time. The temperature of the separation screen 110 may have already caused the tobacco to be over-heated or burned. By providing the second temperature sensor 220 which detects the temperature of the separation screen 110 at all times, the occurrence of the above situation can be effectively avoided.

In another embodiment, the hot end T+ of the thermocouple is arranged in the through hole 135 of the heat-conducting rod 133 for detecting the temperature of the heating chamber 130. Normally, the temperature of the separation screen 110 changes synchronously with the temperature of the heating chamber 130. To detect the temperature in the heating chamber 130 is to indirectly detect the temperature of the separation screen 110, which can also achieve the purpose of monitoring the temperature of the separation screen 110.

As shown in FIG. 3, in this embodiment, the temperature detection module 200 also includes a resistance detection module 137, and the resistance detection module 137 is configured to detect a resistance of the heating wire 134 to obtain the temperature of the heating wire 134. Specifically, the resistance detection module 137 includes a detection operational amplifier unit U2, a detection resistor R8, a sixth voltage divider resistor R6, and a seventh voltage divider resistor R7. One end of the heating wire 134 is connected to a power switch tube of the power supply 400, and the other end is connected in series with the detection resistor R8 and grounded through the detection resistor R8. a common end of the detection resistor R8 and the heating wire 134 is connected with a positive input pin IN+ of the detection operational amplifier unit U2 through the sixth voltage divider resistor R6. A common end of the detection resistor R8 and the ground is connected with a negative input pin IN-of the detection operational amplifier unit U2 through the seventh voltage divider resistor R7. An output pin OUT of the detection operational amplifier unit U2 is connected to a second input end AD2 of the main control module 300, a voltage stabilizing capacitor C2 is connected in series between the positive input pin IN+ and the negative input pin IN-.

It should be noted that when the power switch tube is turned on, the power supply 400 provides a driving voltage to the heating wire 134 so that a temperature of the heating wire 134 starts to rise. At the same time, due to the TCR (temperature coefficient of resistance) characteristic of the heating wire 134, a temperature change of the heating wire 134 will cause the resistance of the heating wire 134 to change accordingly, so that the voltage applied to the detection resistor R8 will also change. Through the operational amplifier unit U2, the voltage across the detection resistor R8 can be collected and a detection voltage generated based on the voltage at the two end is transmitted to the main control module 300. The main control module 300 may indirectly obtain the resistance change of the heating wire 134 according to the change of the detection voltage (voltage at the two ends), and finally obtain the temperature corresponding to the heating wire 134 according to the TCR characteristic of the heating wire 134, thereby achieving the temperature detection of the heating wire 134. The temperature of the heating wire 134 may also be used as a heating temperature to control the heating device 131.

In this embodiment, a heat-insulating conduit 500 may also be included, and the heat-insulating conduit 500 is sleeved on the outside of the heating conduit 100. Specifically, the heat-insulating conduit 500 is a vacuum heat-insulating conduit, and a vacuum heat insulation layer is provided between the heat-insulating conduit 500 and the heating conduit 100.

In accordance with a second aspect of the embodiments of the present application, it is provided a smoking set, as shown in FIGS. 1, 2 and 3, the smoking set includes a power supply 400 and the device for air conduction heating as above-mentioned. The power supply 400 includes a working voltage end VCC and a power switch tube. The power supply 400 are respectively connected to the main control module 300, the heating device 131, and the temperature detection module 200 to supply power to the main control module 300, the heating device 131, and the temperature detection module 200.

The end of the heating chamber 130 where the air inlet 132 is provided is also provided with a base 600, and an air inlet passage in communication with the air inlet 132 is provided in the base 600.

The functional units in various embodiments of the present application may be integrated into one processing unit, or each unit may exist alone physically, or two or more units may be integrated into one unit. The above-mentioned integrated unit can be implemented in the form of hardware or in the form of software functional unit.

The above-mentioned embodiments are merely used for illustrating the technical solutions of the present application, and are not intended to limit the present application. Although the present application has been described in detail with reference to the foregoing embodiments, it should be understood that for those of ordinary skill in the art, the technical solutions recorded in varies embodiments as aforementioned can be modified, or some of the technical features can be equivalently replaced. These modifications or replacements do not cause the essence of the corresponding technical solutions to deviate from the spirit and scope of the technical solutions of the embodiments of the present application, and should be included within the protection scope of the present application.

What is claimed is:

1. A device for air conduction heating, comprising:
a heating conduit, an inner cavity of the heating conduit being provided with a separation screen, the separation screen being configured to separate the inner cavity into a smoke chamber and a heating chamber, and a heating device being provided in the heating chamber;
a temperature detection module, comprising:
a first temperature sensor, arranged on the smoke chamber, and configured to collect a smoke-chamber temperature of the smoke chamber; and
a second temperature sensor, arranged on the separation screen, and configured to collect a heating temperature of the separation screen; and
a main control module, electrically connected to the heating device and the temperature detection module respectively, and configured to adjust a working power of the heating device according to a relationship between a preset temperature threshold and a detection temperature collected by the temperature detection module, the detection temperature comprising the smoke-chamber temperature and the heating temperature.

2. The device for air conduction heating according to claim 1, wherein one end of the heating chamber is further provided with an air inlet, and one end of the smoke chamber is provided with an air outlet, so that an air-heating diversion channel from the air inlet to the air outlet is formed in the heating conduit.

3. The device for air conduction heating according to claim 2, wherein the heating device comprises a heat-conducting rod and a heating wire; the heat-conducting rod is fixed in the heating chamber; the heating wire is wound on a surface of the heat-conducting rod.

4. The device for air conduction heating according to claim 3, wherein the heat-conducting rod is provided with a through hole along an axial direction of the heat-conducting rod, the surface of the heat-conducting rod is provided with a spiral groove, a heating airway is formed between the spiral groove and an inner wall of the heating chamber, one end of the heating airway is in communication with the air inlet, the other end of the heating airway is in communication with the separation screen, and the heating wire passes through the through hole is spirally wound on the surface of the heat-conducting rod along the spiral groove.

5. The device for air conduction heating according to claim 1, wherein the first temperature sensor comprises a plurality of thermistors connected to the main control module, and the plurality of thermistors are dispersed and fixed on an outer wall of the smoke chamber, and the main control module is configured to obtain the smoke-chamber temperature through the plurality of thermistors.

6. The device for air conduction heating according to claim 1, wherein the second temperature sensor comprises a thermocouple, and a hot end of the thermocouple is arranged on the separation screen.

7. The device for air conduction heating according to claim 6, wherein the second temperature sensor further comprises a first voltage divider resistor, a second voltage divider resistor, a third voltage divider resistor, a fourth voltage divider resistor, a fifth voltage divider resistor, an operational amplifier, and a compensation thermistor;
the hot end of the thermocouple is connected to a non-inverting input end of the operational amplifier through the first voltage divider resistor, a cold end of the thermocouple is connected to an inverting input end of the operational amplifier through the second voltage divider resistor, an output end of the operational amplifier is connected to the inverting input end of the operational amplifier through the third voltage divider resistor, the non-inverting input end of the operational amplifier is further grounded through the fourth voltage divider resistor, and the cold end of the thermocouple is further connected to a working voltage end through the fifth voltage divider resistor;
the cold end of the thermocouple is further grounded through the compensation thermistor; and
the output end of the operational amplifier is connected to the main control module.

8. The device for air conduction heating according to claim 3, wherein the temperature detection module further comprises a resistance detection module, the resistance detection module comprises a detection resistor, and the detection resistor is connected in series with the heating wire and is grounded, the resistance detection module is configured to collect a voltage at two ends of the detection resistor, and the main control module is further configured to obtain a temperature of the heating wire according to the voltage at the two ends.

9. The device for air conduction heating according to claim 1, wherein the preset temperature threshold comprises a first heating temperature threshold and a second heating temperature threshold, and the first heating temperature threshold is smaller than the second heating temperature threshold;
the main control module is further configured to control the heating device to perform heating at a rated power when the heating temperature is smaller than the first heating temperature threshold, to control the heating device to perform heating at a power lower than the rated power after the heating temperature reaches the first heating temperature threshold, and to control the heating device to stop heating for a preset time when the heating temperature reaches the second heating temperature threshold.

10. A smoking set, comprising a device for air conduction heating, the device comprising:
a heating conduit, an inner cavity of the heating conduit being provided with a separation screen, the separation screen being configured to separate the inner cavity into a smoke chamber and a heating chamber, and a heating device being provided in the heating chamber;
a temperature detection module, comprising:
a first temperature sensor, arranged on the smoke chamber, and configured to collect a smoke-chamber temperature of the smoke chamber; and
a second temperature sensor, arranged on the separation screen, and configured to collect a heating temperature of the separation screen;
a main control module, electrically connected to the heating device and the temperature detection module respectively, and configured to adjust a working power of the heating device according to a relationship between a preset temperature threshold and a detection temperature collected by the temperature detection module, the detection temperature comprising the smoke-chamber temperature and the heating temperature.

11. The smoking set according to claim 10, wherein one end of the heating chamber is further provided with an air inlet, and one end of the smoke chamber is provided with an air outlet, so that an air-heating diversion channel from the air inlet to the air outlet is formed in the heating conduit.

12. The smoking set according to claim 11, wherein the heating device comprises a heat-conducting rod and a heating wire; the heat-conducting rod is fixed in the heating chamber; the heating wire is wound on a surface of the heat-conducting rod.

13. The smoking set according to claim 12, wherein the heat-conducting rod is provided with a through hole along an axial direction of the heat-conducting rod, the surface of the heat-conducting rod is provided with a spiral groove, a heating airway is formed between the spiral groove and an inner wall of the heating chamber, one end of the heating airway is in communication with the air inlet, the other end of the heating airway is in communication with the separation screen, and the heating wire passes through the through hole is spirally wound on the surface of the heat-conducting rod along the spiral groove.

14. The smoking set according to claim 10, wherein the first temperature sensor comprises a plurality of thermistors connected to the main control module, and the plurality of thermistors are dispersed and fixed on an outer wall of the smoke chamber, and the main control module is configured to obtain the smoke-chamber temperature through the plurality of thermistors.

15. The smoking set according to claim 10, wherein the second temperature sensor comprises a thermocouple, and a hot end of the thermocouple is arranged on the separation screen.

16. The smoking set according to claim 15, wherein the second temperature sensor further comprises a first voltage divider resistor, a second voltage divider resistor, a third voltage divider resistor, a fourth voltage divider resistor, a fifth voltage divider resistor, an operational amplifier, and a compensation thermistor;
the hot end of the thermocouple is connected to a non-inverting input end of the operational amplifier through the first voltage divider resistor, a cold end of the thermocouple is connected to an inverting input end of the operational amplifier through the second voltage divider resistor, an output end of the operational amplifier is connected to the inverting input end of the operational amplifier through the third voltage divider resistor, the non-inverting input end of the operational amplifier is further grounded through the fourth voltage divider resistor, and the cold end of the thermocouple is further connected to a working voltage end through the fifth voltage divider resistor;
the cold end of the thermocouple is further grounded through the compensation thermistor; and
the output end of the operational amplifier is connected to the main control module.

17. The smoking set according to claim 12, wherein the temperature detection module further comprises a resistance detection module, the resistance detection module comprises a detection resistor, and the detection resistor is connected in series with the heating wire and is grounded, the resistance detection module is configured to collect a voltage at two ends of the detection resistor, and the main control module is further configured to obtain a temperature of the heating wire according to the voltage at the two ends.

18. The smoking set according to claim 10, wherein the preset temperature threshold comprises a first heating temperature threshold and a second heating temperature threshold, and the first heating temperature threshold is smaller than the second heating temperature threshold;
the main control module is further configured to control the heating device to perform heating at a rated power when the heating temperature is smaller than the first heating temperature threshold, to control the heating device to perform heating at a power lower than the rated power after the heating temperature reaches the first heating temperature threshold, and to control the heating device to stop heating for a preset time when the heating temperature reaches the second heating temperature threshold.
